(19) United States
(12) Patent Application Publication
(10) Pub. No.: US 2024/0106644 A1
(43) Pub. Date: Mar. 28, 2024

(54) MITIGATION OF SIDE CHANNEL ATTACKS ON PLATFORM INTERCONNECTS USING ENDPOINT HARDWARE BASED DETECTION, SYNCHRONIZATION AND RE-KEYING

(71) Applicant: Intel Corporation, Santa Clara, CA (US)

(72) Inventors: Aditya Katragada, Austin, TX (US); Geoffrey Strongin, Tigard, OR (US); Prakash Iyer, Portland, OR (US); Rajesh Banginwar, Bangalore (IN); Poh Thiam Teoh, Penang (MY); Gary Wallichs, San Jose, CA (US)

(73) Assignee: Intel Corporation, Santa Clara, CA (US)

(21) Appl. No.: 17/954,157

(22) Filed: Sep. 27, 2022

(51) Int. Cl. H04L 9/08

(52) U.S. Cl. CPC H04L 9/0891; H04L 9/0894

(57) ABSTRACT

A system and method of enhancing the mitigation of side channel attacks on platform interconnects using endpoint HW based detection, synchronization, and re-keying include generating a set of keys for link encryption based on a high entropy seed, storing the set of keys in a deterministic order in a register, detecting that a re-key programmable threshold is met during link encryption with a device, identifying a synchronization point associated with the device, where the synchronization point indicates the device is ready to switch a current key used for link encryption, and synchronizing a rekeying event with the device.

### FIELD

Embodiments relate generally to computer security, and more particularly, to the mitigation of side channel attacks on platform interconnects using endpoint hardware (HW) based detection, synchronization, and re-keying.

### BACKGROUND

Data confidentiality and Integrity across interconnects like Peripheral Component Interconnect Express (PCIe) are becoming more mainstream and are generally met by encrypting the data using a symmetric Crypto algorithm like Advanced Encryption Standard (AES) standard. For example, the Integrity and Data Encryption (IDE) Engineering Change Notification (ECN) PCIe Gen5 onwards uses AES Galois Counter Mode (GCM) with 256-bit key sizes to protect data across the links. Symmetric crypto engines are susceptible to side channel attacks using Differential Power Analysis (DPA) or Differential Electromagnetic Analysis (DEMA). DPA/DEMA resistance built into AES cores is very expensive and may not be an option for Field Programmable Gate Arrays (FPGAs) like devices that require support of more than 4 controllers with full PCIe bandwidth.

One of the solutions that currently exist to mitigate DPA attacks within AES cores focus on reducing signal to noise ratio by data masking techniques where power or Electro Magnetic (EM) leakage during the AES round operations is masked. Another technique to mitigate AES DPA/DEMA attacks is to prevent a large amount of data using the same key to reduce the usefulness or the Return of Investment (ROI) of a successful DPA attack using re-keying. These solutions are very complex, expensive, bulky and require upwards of a million plus gates.

### BRIEF DESCRIPTION OF THE DRAWINGS

So that the manner in which the above recited features of the present embodiments can be understood in detail, a more particular description of the embodiments, briefly summarized above, may be had by reference to embodiments, some of which are illustrated in the appended drawings. It is to be noted, however, that the appended drawings illustrate only typical embodiments and are therefore not to be considered limiting of its scope. The figures are not to scale. In general, the same reference numbers will be used throughout the drawings and accompanying written description to refer to the same or like parts.

FIG. 1 illustrates a computing device employing a rekey mechanism according to some embodiments.

FIG. 2A illustrates the rekey mechanism of FIG. 1 according to some embodiments.

FIG. 2B illustrates the rekey mechanism of the detection, synchronization, and rekeying device of FIG. 3 according to some embodiments.

FIG. 3 illustrates the computing device of FIG. 1 according to some embodiments.

FIG. 4 illustrates an example of platform interconnects for mitigating side channel attacks according to some embodiments.

FIG. 5 illustrates the platform interconnects of FIG. 4 including a rekey HW block according to some embodiments.

FIG. 6 illustrates the rekey HW block of FIG. 5 according to some embodiments.

FIG. 7 illustrates a method for mitigating side channel attacks according to some embodiments.

FIG. 8A is a schematic diagram of an illustrative electronic computing device to enhance the mitigation of side channel attacks processing according to some embodiments.

FIG. 8B is a schematic diagram of an illustrative electronic computing device to enhance the mitigation of side channel attacks processing according to some embodiments.

### DETAILED DESCRIPTION

Implementations of the technology described herein provide a method and system for mitigation of side channel attacks on platform interconnects using endpoint hardware (HW) based detection, synchronization, and re-keying.

Data confidentiality and Integrity across interconnects like Peripheral Component Interconnect Express (PCIe) are becoming more mainstream and are generally met by encrypting the data using a symmetric Crypto algorithm like AES standard. AES engines required to meet throughputs in the range of 400 Gbps (ex: PCIe Gen5 speeds) may be very bulky and upwards of million plus gates. DPA protected AES cores may be several times the size of the AES cores without DPA depending on how robust the data masking mitigations are. In most products it may not be feasible to instantiate such bulky AES engines and if it can be done, it gets very expensive with respect to silicon die cost. Mitigation using Key refresh is a valid alternate option but when an endpoint is trying to source or sink hundreds of Gbps of data (which translates to millions of AES traces) it adds challenges that makes re-keying very complex.

Software (SW) based key negotiation and updates may not be fast enough to prevent an attacker from collecting large amounts of data and power traces to successfully launch a DPA attack. For example, re-keying frequently is not possible using SW methods (e.g., like those described in the IDE specification) for interfaces like PCIe supporting greater than a hundred Gbps bandwidth.

Even re-keying using HW requires the two endpoints to synchronize on the re-key point and the key switch trigger must be done precisely at the right data boundary to prevent data corruption due to mismatched keys and must be done without stalling the links. This is a hard problem to solve for interfaces like PCIe supporting greater than a hundred Gbps bandwidth.

The novel technology described herein facilitates the mitigation of DPA attacks on Symmetric Crypto engines protecting data across interconnects. In one example, the novel technology is implemented in a network interface card (NIC) that works with a system on a chip (SOC) with compliance to Confidential Compute requirements, e.g., Trusted Execution Environment Input/Output (TEE-I/O) specifications.

In embodiments, a method and apparatus may be implemented in an FPGA to mitigate DPA attacks on an interconnect link (e.g., the PCIe link) using a combination hardware block comprising a configurable rekey frequency detector, hardware based key generation, storage, and key updater and a HW logic that drives synchronization with the other end and key switching. In one example, the combination hardware block may detect when to rekey, synchronize the key switching, generate keys, and exchange and time the key switch while not taking the link down or losing sync with the other end or losing bandwidth due to the flow. In one example, the combination hardware block may support the re-key flow with PCIe connections to any root port with or without any specific HW changes to the root port SOC.

The novel technology described herein facilitates implementation of DPA side channel attack mitigations using very minimal area increase. The HW based implementation of the flow may only add a few 10's of K gates when compared to adding millions of gates for data masking-based AES DPA mitigation techniques per AES core, thus saving valuable die area. Furthermore, the novel technology described herein provides configurability and flexibility to characterize the DPA mitigation in post silicon. DPA attacks can never be reliably validated in pre-silicon since the DPA attacks are based on signal to noise ratios on power traces and Pre-silicon simulations lack noise. Masking techniques once implemented may require a silicon step if the solution does not meet the DPA resistance required. The rekey frequency for the technology described herein may be made more stringent or relaxed based on post silicon characterization and the power tradeoff that the platform needs to achieve. The re-key HW block described herein may seamlessly integrate into current link encryption flows without any changes to protocol.

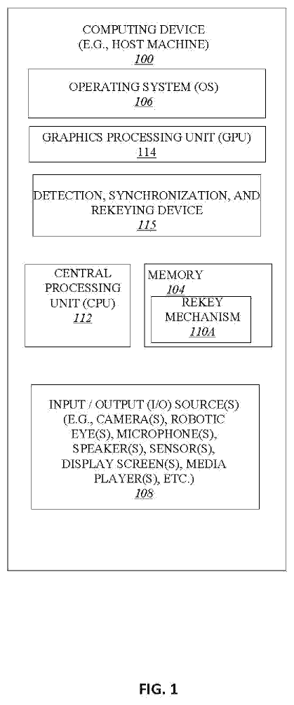

FIG. 1 illustrates a computing device 100 employing a rekey mechanism 110A according to one embodiment. Computing device 100 represents a communication and data processing device including or representing (without limitation) smart voice command devices, intelligent personal assistants, home/office automation system, home appliances (e.g., washing machines, television sets, etc.), mobile devices (e.g., smartphones, tablet computers, etc.), gaming devices, handheld devices, wearable devices (e.g., smartwatches, smart bracelets, etc.), virtual reality (VR) devices, head-mounted displays (HMDs), Internet of Things (IoT) devices, laptop computers, desktop computers, server computers, set-top boxes (e.g., Internet-based cable television set-top boxes, etc.), global positioning system (GPS)-based devices, automotive infotainment devices, etc.

In some embodiments, computing device 100 includes or works with or is embedded in or facilitates any number and type of other smart devices, such as (without limitation) autonomous machines or artificially intelligent agents, such as a mechanical agents or machines, electronics agents or machines, virtual agents or machines, electro-mechanical agents or machines, etc. Examples of autonomous machines or artificially intelligent agents may include (without limitation) robots, autonomous vehicles (e.g., self-driving cars, self-flying planes, self-sailing boats, etc.), autonomous equipment (self-operating construction vehicles, self-operating medical equipment, etc.), and/or the like. Further, “autonomous vehicles” are not limited to automobiles but that they may include any number and type of autonomous machines, such as robots, autonomous equipment, household autonomous devices, and/or the like, and any one or more tasks or operations relating to such autonomous machines may be interchangeably referenced with autonomous driving.

Further, for example, computing device 100 may include a computer platform hosting an integrated circuit (“IC”), such as a system on a chip (“SoC” or “SOC”), integrating various hardware and/or software components of computing device 100 on a single chip. For example, computing device 100 comprises a data processing device having one or more processors including (but not limited to) central processing unit 112 and graphics processing unit 114 that are co-located on a common semiconductor package.

As illustrated, in one embodiment, computing device 100 may include any number and type of hardware and/or software components, such as (without limitation) graphics processing unit (“GPU” or simply “graphics processor”) 114, central processing unit (“CPU” or simply “application processor”) 112, detection, synchronization, and rekeying device 115, memory 104, network devices, drivers, and/or the like, as well as input/output (I/O) source(s) 108, such as touchscreens, touch panels, touch pads, virtual or regular keyboards, virtual or regular mice, ports, connectors, etc. Computing device 100 may include operating system (OS) 106 serving as an interface between hardware and/or physical resources of the computing device 100 and a user.

It is to be appreciated that a lesser or more equipped system than the example described above may be preferred for certain implementations. Therefore, any configuration of computing device 100 may vary from implementation to implementation depending upon numerous factors, such as price constraints, performance requirements, technological improvements, or other circumstances.

Embodiments may be implemented as any or a combination of: one or more microchips or integrated circuits interconnected using a parent board, hardwired logic, software stored by a memory device and executed by a microprocessor, firmware, an application specific integrated circuit (ASIC), and/or a field programmable gate array (FPGA). Terms like “logic”, “module”, “component”, “engine”, “circuitry”, “element”, and “mechanism” may include, by way of example, software, hardware, firmware, and/or a combination thereof.

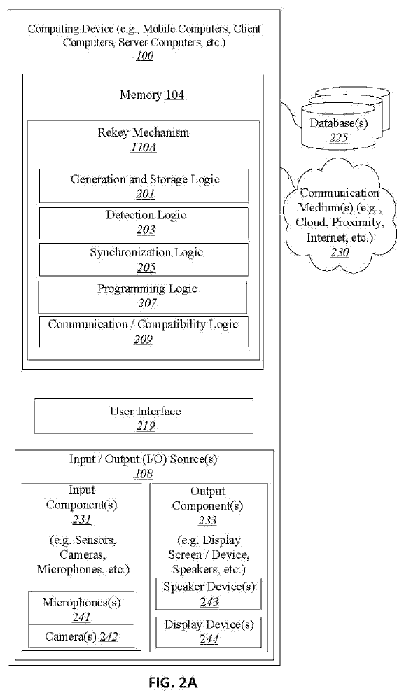

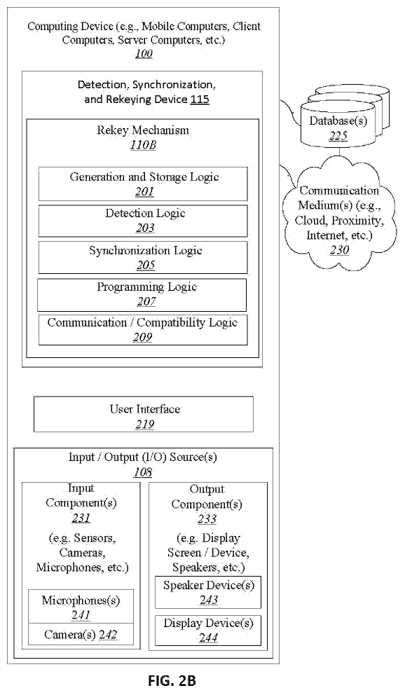

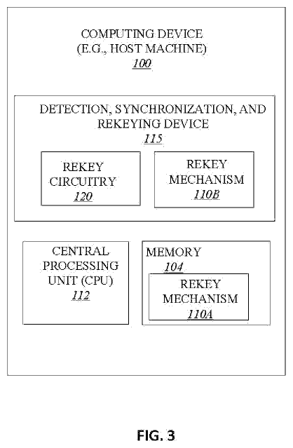

In one embodiment, as illustrated, the rekey mechanism 110A may be hosted by memory 104 (e.g., in the form of instructions stored in memory 104 as shown in FIG. 2A) in communication with I/O source(s) 108, such as sensors, microphones, speakers, etc., of computing device 100. In another embodiment, rekey mechanism 110A may be part of or hosted by operating system 106. As illustrated in FIG. 3, detection, synchronization, and rekeying device 115 employs a rekey mechanism 110B according to one embodiment. Accordingly, in one embodiment, the rekey mechanism 110B may be hosted by or part of detection, synchronization, and rekeying device 115 or firmware of detection, synchronization, and rekeying device 115; for example, rekey mechanism 110B may be embedded in (e.g., as shown in FIG. 2B) or implemented as part of the processing hardware of detection, synchronization, and rekeying device 115 in the form of rekey circuitry 120.

For example, rekey circuitry 120 and/or any elements of rekey mechanisms 110A/110B may be implemented by one or more analog or digital circuits, logic circuits, programmable processors, programmable controllers, GPUs, digital signal processors (DSPs), application specific integrated circuits (ASICs), programmable logic devices (PLDs), and/or field programmable gate arrays (FPGAs).

It is contemplated that this novel technique is not limited to a software implementation or a hardware implementation and, as will be further described in this document, this novel technique may be applied and implemented in software, hardware, firmware, or any combination thereof. It is, therefore, further contemplated that embodiments are not limited to certain implementation or hosting of rekey mechanisms 110A/110B and that one or more portions or components of rekey mechanisms 110A/110B may be employed or implemented as hardware, software, firmware, or any combination thereof. Further, as used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events

Computing device 100 may host network interface device(s) to provide access to a network, such as a LAN, a wide area network (WAN), a metropolitan area network (MAN), a personal area network (PAN), Bluetooth, a cloud network, a mobile network (e.g., 3rd Generation (3G), 4th Generation (4G), etc.), an intranet, the Internet, etc. Network interface(s) may include, for example, a wireless network interface having antenna, which may represent one or more antenna(e). Network interface(s) may also include, for example, a wired network interface to communicate with remote devices via network cable, which may be, for example, an Ethernet cable, a coaxial cable, a fiber optic cable, a serial cable, or a parallel cable.

Embodiments may be provided, for example, as a computer program product which may include one or more machine-readable media having stored thereon machine-executable instructions that, when executed by one or more machines such as a computer, a data processing machine, a data processing device, network of computers, or other electronic devices, may result in the one or more machines carrying out operations in accordance with embodiments described herein. As described with reference to FIG. 1, a machine may include one or more processors, such as a CPU, a GPU, etc. A machine-readable medium may include, but is not limited to, floppy diskettes, optical disks, Compact Disc-Read Only Memories (CD-ROMs), magneto-optical disks, ROMs, Random Access Memories (RAMs), Erasable Programmable Read Only Memories (EPROMs), Electrically Erasable Programmable Read Only Memories (EEPROMs), magnetic or optical cards, flash memory, or other type of media/machine-readable medium suitable for storing machine-executable instructions.

For example, when reading any of the apparatus, method, or system claims of this disclosure to cover a purely software and/or firmware implementation, at least one element of rekey circuitry 120 and/or rekey mechanisms 110A/110B may be expressly defined to include a non-transitory computer readable storage device or storage disk such as a memory, a digital versatile disk (DVD), a compact disk (CD), a Blu-ray disk, etc., including the software and/or firmware.

Moreover, one or more elements of rekey circuitry 120 or rekey mechanisms 110A/110B may be downloaded as a computer program product, wherein the program may be transferred from a remote computer (e.g., a server) to a requesting computer (e.g., a client) by way of one or more data signals embodied in and/or modulated by a carrier wave or other propagation medium via a communication link (e.g., a modem and/or network connection).

It is to be noted that terms like “node”, “computing node”, “server”, “server device”, “cloud computer”, “cloud server”, “cloud server computer”, “machine”, “host machine”, “device”, “computing device”, “computer”, “computing system”, and the like, may be used interchangeably throughout this document. It is to be further noted that terms like “application”, “software application”, “program”, “software program”, “package”, “software package”, and the like, may be used interchangeably throughout this document.

FIG. 2A illustrates rekey mechanism 110A of FIG. 1 according to some embodiments. For brevity, many of the details already discussed with reference to FIG. 1 are not repeated or discussed hereafter. In one embodiment, rekey mechanism 110A may include any number and type of elements or components, such as (but not limited to): generation and storage logic 201; detection logic 203; synchronization logic 205; programming logic 207; and communication/compatibility logic 209.

FIG. 2B illustrates rekey mechanism 110B of FIG. 3 according to some embodiments. For brevity, many of the details already discussed with reference to FIG. 3 are not repeated or discussed hereafter. In one embodiment, rekey mechanism 110B may include any number and type of elements or components, such as (but not limited to): generation and storage logic 201; detection logic 203; synchronization logic 205; programming logic 207; and communication/compatibility logic 209.

Computing device 100 further includes user interface 219 (e.g., graphical user interface (GUI)-based user interface, Web browser, cloud-based platform user interface, software application-based user interface, other user or application programming interfaces (APIs), etc.). Computing device 100 may further include I/O source(s) 108 having input component(s) 231, such as camera(s) 242 (e.g., Intel® RealSense™ camera), microphone(s) 241, sensors, detectors, keyboards, mice, etc., and output component(s) 233, such as display device(s) or simply display(s) 244 (e.g., integral displays, tensor displays, projection screens, display screens, etc.), speaker devices(s) or simply speaker(s), etc.

Computing device 100 is further illustrated as having access to and/or being in communication with one or more database(s) 225 and/or one or more of other computing devices over one or more communication medium(s) 230 (e.g., networks such as a proximity network, a cloud network, an intranet, the Internet, etc.).

In some embodiments, database(s) 225 may include one or more of storage mediums or devices, repositories, data sources, etc., having any amount and type of information, such as data, metadata, etc., relating to any number and type of applications, such as data and/or metadata relating to one or more users, physical locations or areas, applicable laws, policies and/or regulations, user preferences and/or profiles, security and/or authentication data, historical and/or preferred details, and/or the like.

As aforementioned, computing device 100 may host I/O source(s) 108 including input component(s) 231 and output component(s) 233. In one embodiment, input component(s) 231 may include a sensor array including, but not limited to, microphone(s) 241, camera(s) 242, capacitors, radio components, radar components, scanners (e.g., fingerprint scanners), and/or accelerometers, etc. Similarly, output component(s) 233 may include any number and type of display device(s) 244, projectors, light-emitting diodes (LEDs), speaker(s) 243, and/or vibration motors, etc.

As aforementioned, terms like “logic”, “module”, “component”, “engine”, “circuitry”, “element”, and “mechanism” may include, by way of example, software, hardware, firmware, and/or any combination thereof. For example, logic may itself include or be associated with circuitry at one or more devices, such as rekey circuitry 120 hosted by the detection, synchronization, and rekeying device 115, respectively, of FIG. 3 having to facilitate or execute the corresponding logic to perform certain tasks.

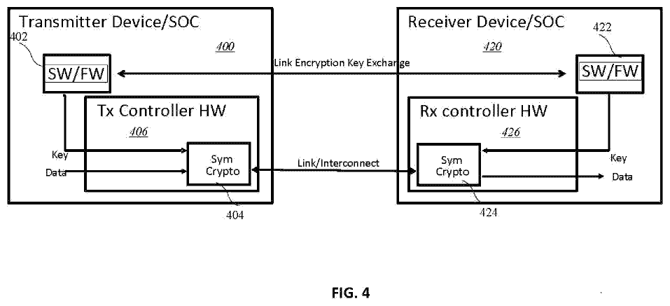

With reference now to FIG. 4, platform interconnects for mitigating side channel attacks using endpoint HW detection, synchronization and rekeying are illustrated. As shown, the platform includes a transmitter device 400 and a receiver device 420 connected using interconnects that implement link encryption. In one example, the transmitter device 400 and the receiver device 420 may be any two devices that may be implemented as interconnects for link encryption between the two devices. For example, the transmitter device 400 and the receiver device 420 may be a SOC and include a CPU (e.g., the CPU 112 illustrated in FIG. 1), an FPGA, a smart-NIC, storage, HW accelerator, I/O device, and the like. In another example, the transmitter device 400 and the receiver device 420 may include the detection, synchronization and rekeying device 115 as illustrated in FIGS. 1 and 3.

In one example, the interconnects are PCIe for link encryption. As such, as illustrated in FIG. 4, the transmitter device 400 includes driver components 402, interconnect controller 406 and symmetric crypto 404 and the receiver device 420 includes driver components 422, interconnect controller 426, and symmetric crypto 424. In one example, the driver components 402/422 include SW or firmware driver components driving the interconnect controller 406/426, respectively. In one example, the interconnect controllers 406/426 include PCIe or other communication endpoints or root ports. In one example, the symmetric crypto 404/424 may be configured to implement link encryption. As such, link encryption may be enabled on the platform illustrated in FIG. 4.

In one example, the driver components 402/422 may provide the symmetric crypto 404/424 with keys used for encryption/decryption. The data that gets encrypted in the transmitter device 400 and decrypted in the receiver device 420 passes through the link interconnect between the two interconnect controllers 406/426. In one example, SW components on the transmitter device 400 and the receiver device 420 may use at least one of an in-band method or an out of band method to identify and mutually authenticate each other. The transmitter device 400 and the receiver device 420 may then negotiate and exchange keys for encryption/decryption using the link encryption key exchange. The driver components 402/422 may provide the symmetric crypto 404/424 with keys used for encryption/decryption to turn on link encryption. Subsequently, the data transmitted by the transmitter device 400 is encrypted on the transmitter interconnect controller 406 and decrypted on the receiver interconnect controller 426 before being consumed by the receiver device 420.

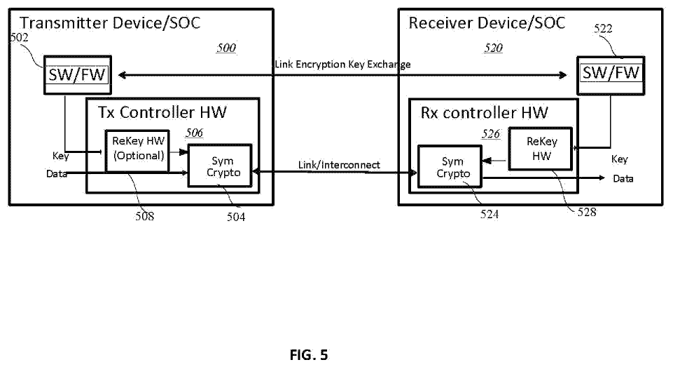

With reference now to FIG. 5, platform interconnects for mitigating side channel attacks using endpoint HW detection, synchronization and rekeying are illustrated. As shown, the platform includes a transmitter device 500 and a receiver device 520 connected using interconnects that implement link encryption. As illustrated in FIG. 5, the transmitter device 500 includes driver components 502, interconnect controller 506, symmetric crypto 504, and optional rekey HW 508 and the receiver device 520 includes driver components 522, interconnect controller 526, symmetric crypto 524, and rekey HW 528. It is appreciated that the platform shown in FIG. 5 includes all the functionality described with respect to FIG. 4. Therefore, for brevity, many of the details already discussed with reference to FIG. 4 are not repeated or discussed hereafter. In one implementation, the rekey HW 528 facilitates key refresh to enable side channel resistance on the symmetric crypto 504/524. In another implementation, both the rekey HW 528 and the optional rekey HW 508 facilitate key refresh to enable side channel resistance on the symmetric crypto 504/524.

In one example, the rekey HW 528 may be configured to detect when to rekey based on one or more conditions, generate keys based on a known seed or an initial key, store the generated keys, update the symmetric crypto 524 with the keys, generate a synchronization point with a root port to refresh the keys, trigger the root port to change a current key with a next agreed upon key, and check for a synchronization point with the root port.

In one example, the optional rekey HW 508 may be implemented in the PCIe root port and may be configured to generate keys based on a known seed or an initial key, store the generated keys, update the symmetric crypto 504 with the keys when triggered, check for a synchronization point with the root port, and generate a synchronization point with the end point to refresh the keys. In one example, when the Root port does not have the optional rekey HW 508 the Root port may be configured to store the generated keys in the driver components 502 and update/refresh the symmetric crypto 504 with the keys. The key generator may be implemented elsewhere.

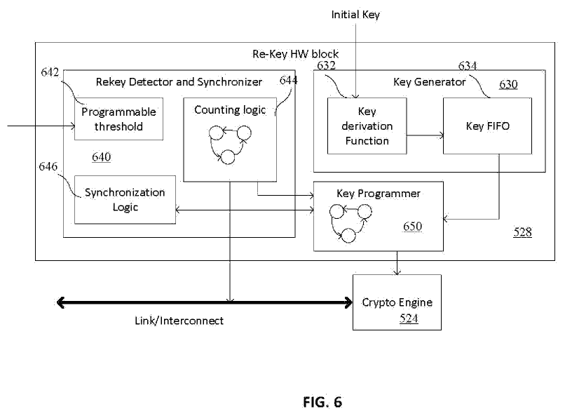

With reference now to FIG. 6, as illustrated, rekey HW 528 may include a key generator 630, a detector and synchronizer 640 and a key programmer 650. The key generator 630 may include a key derivation function 632 and a key first in first out (FIFO) 634. In one embodiment, with reference again to FIGS. 2A/2B, generation and storage logic 201 generates a set of keys for link encryption based on a high entropy seed. For example, the high entropy seed may be received at the key derivation function 632. In one example, the high entropy seed may be exchanged between the root port and the end point. In one example, at least one of the root port and end point may generate the set of keys for future refreshes and transmit them using the same channel that was used to transmit either the high entropy seed or the initial key. The key derivation function 632 may generate the set of keys using the high entropy seed for storage in the key FIFO 634. As such, in another embodiment, generation and storage logic 201 stores the set of keys in a deterministic order in a register. In this example, the register used for storage is the key FIFO 634.

In one example, the deterministic order for storing the keys in the register (e.g., the key FIFO 634) facilitates synchronization of keys to be used for link encryption. In some examples, for PCIe the deterministic order on the endpoint is that the first key in the key FIFO 634 is for Posted stream on transmit (Tx), the second key is for Non-Posted Tx and the third key is for completions Tx substreams. The equivalent order on the Root port is the first key for posted receive (Rx), the second key for Rx Non Posted and the third key for Completions Rx substreams. As such, the Rx and the Tx use the same key on every key switch. In one implementation, when the Root port does not have the optional rekey HW 508 the Root port key register could be stored in SW memory and its key generator could be implemented elsewhere. In one example, the Root port key generator could be implemented using SW based Key Derivation Function (KDF).

As illustrated in FIG. 6, the detector and synchronizer 640 may include programmable threshold 642, counting logic 644, and synchronization logic 646. The programmable threshold 642 may include programmable thresholds on when to rekey (e.g., rekey programmable thresholds). In one example, the programmable threshold 642 is a register that may be programmed with SW to monitor and the threshold on when to rekey. In one example, the programmable threshold 642 may be programmed based on how strong of a DPA resistance is required for this use case for the crypto used in this link encryption and how vulnerable this Crypto is to DPA attacks. The programmable threshold 642 may include one or more conditions to set up a rekeying frequency. In one example, the one or more conditions include at least one of an amount of time since a last key update, a number of bytes since a last key update, a number of packets since a last key update and any other specific means. In another example, the one or more conditions may include other system or protocol generated events or SW deciding on external events like interrupts, Vendor Defined Messages (VDMs) or Transaction Later Packets (TLPs).

In one example, counting logic 644 may be configured to count towards the rekey programmable thresholds. In one example, the rekey programmable thresholds are TLP counters and the counting logic 644 may count incoming or outgoing TLPs (e.g., based on the direction of data traffic) until the rekey programmable threshold is met.

With reference again to FIGS. 2A/2B, detection logic 203 detects that a rekey programmable threshold is met during link encryption with a device (e.g., at the opposite end of the connection). The device may include any device discussed herein relative to FIGS. 1 and 3. In one example, the device is the transmitter device 500 and includes a PCIe root port connected to the end point (e.g., Rx interconnect controller 526). When detection logic 203 detects that a rekey programmable threshold is met during link encryption with the device, synchronization logic 205 and/or synchronization logic 646 identifies a synchronization point associated with the device. In one example, the synchronization point indicates the device is ready to switch a current key used for link encryption. For example, initially both end points (e.g., both the Tx and Rx controller) main key slot and backup key slot may be programmed with the first two keys from the key FIFO 634. The root port SW may program a “ready to rekey” bit on the end point. This bit indicates that the root port is ready to rekey when the first rekey programmable threshold is reached/met. In one example, if the ready to rekey bit is not set, then the keys won't be changed (e.g., rekeying won't occur) when the rekey programmable threshold is met.

After a synchronization point is identified, synchronization logic 205 synchronizes a rekeying event with the device. For example, key programmer 650 may receive an indication as a signal from synchronization logic 646 to switch keys. For example, key programmer 650 and/or programming logic 207 programs the backup key slot of crypto engine 524 (e.g., symmetric crypto) by pulling a key from the key FIFO 634 and updating the crypto engine 524 with the new key. In one example, the key is switched using a specific protocol. For example, when used on PCIe, the K bit as part of the IDE TLP prefix may be used to switch keys on its IDE sub-streams. In another example, the key is switched using a custom message. In examples, the programming logic 207 and/or the key programmer 650 generates triggers to the other end point to switch the key based on signals from the synchronization logic 646.

In one example, the programming logic 207 provides a trigger to the device indicating to the device that it is time to switch the current key used for link encryption, switches the current key used for link encryption, and generates another synchronization point with the device to program a backup key slot with a next key of the set of keys stored in the register. When the root port of the device receives this trigger, the root port uses this indication as a trigger to switch the key for the subsequent packets and is ready to decrypt the future packets with the new keys. In PCIe link encryption, the trigger may be provided to the device using the K bit in the TLP of next TLP following the TLP when the rekey programmable threshold is met as part of the IDE protocol. In other examples, other protocols may use other triggers like a custom message.

In one example, generating another synchronization point with the device to program a backup key slot with a next key of the set of keys stored in the register comprises the synchronization logic 205 sending a Message Signaled Interrupt (MSI) or VDM signal to the root port of the device. In one example, when the root port receives the interrupt signal, root port SW may program its backup key slot with the next key from the key FIFO 634. In another example, when the optional rekey HW 508 is present in the device, programming logic 207 of the device programs the backup key slot of crypto engine 504 (e.g., symmetric crypto) by pulling a key from the key FIFO 634 and updating the crypto engine 504 with the new key. In another example, generating another synchronization point with the device to program a backup key slot with a next key of the set of keys stored in the register comprises the device setting the “ready to rekey” bit in the end point.

In one example, when the device root port HW or SW identifies it is not ready with the backup key slot (e.g., when SW is busy with other tasks), the “ready to rekey” bit won't be set. When the “ready to rekey” signal/bit is not set, the rekey programmable threshold 642 at the endpoint may let the counter expire. The counting logic 644 may start counting again towards the next rekey programmable threshold. In one example, when the register (e.g., the key FIFO 634) has reached a stored keys threshold, synchronization logic 205 and/or synchronization logic 646 generates a new high entropy seed that is sent to the device as a custom message

It is appreciated that the logic described herein can be performed at both the transmitter device 500 and the receiver device 520 as any combination of software, hardware and/or firmware. In one example, the transmitter device 500 may act as a transmitter or receiver to both send and encrypt data and receive and decrypt data. Similarly, in another example, the receiver device 520 may act as a transmitter or a receiver to both send and encrypt data and receive and decrypt data. In this regard, both the optional rekey HW 508 and the rekey HW 528 may perform any or all the steps described herein relative to FIG. 6. In some examples, some of the steps or all the steps described relative to FIG. 6 may be performed via SW, some of the steps or all the steps described relative to FIG. 6 may be performed via HW, and some of the steps or all the steps described relative to FIG. 6 may be performed via firmware.

It is contemplated that embodiments are not limited to any number or type of use-case scenarios, architectural placements, or component setups; however, for the sake of brevity and clarity, illustrations and descriptions are offered and discussed throughout this document for exemplary purposes but that embodiments are not limited as such. Further, throughout this document, “user” may refer to someone having access to one or more computing devices, such as computing device 100, and may be referenced interchangeably with “person”, “individual”, “human”, “him”, “her”, “child”, “adult”, “viewer”, “player”, “gamer”, “developer”, programmer”, and/or the like.

Communication/compatibility logic 209 may be used to facilitate dynamic communication and compatibility between various components, networks, database(s) 225, and/or communication medium(s) 230, etc., and any number and type of other computing devices (such as wearable computing devices, mobile computing devices, desktop computers, server computing devices, etc.), processing devices (e.g., central processing unit (CPU), graphics processing unit (GPU), etc.), capturing/sensing components (e.g., non-visual data sensors/detectors, such as audio sensors, olfactory sensors, haptic sensors, signal sensors, vibration sensors, chemicals detectors, radio wave detectors, force sensors, weather/temperature sensors, body/biometric sensors, scanners, etc., and visual data sensors/detectors, such as cameras, etc.), user/context-awareness components and/or identification/verification sensors/devices (such as biometric sensors/detectors, scanners, etc.), memory or storage devices, data sources, and/or database(s) (such as data storage devices, hard drives, solid-state drives, hard disks, memory cards or devices, memory circuits, etc.), network(s) (e.g., Cloud network, Internet, Internet of Things, intranet, cellular network, proximity networks, such as Bluetooth, Bluetooth low energy (BLE), Bluetooth Smart, Wi-Fi proximity, Radio Frequency Identification, Near Field Communication, Body Area Network, etc.), wireless or wired communications and relevant protocols (e.g., Wi-Fi®, WiMAX, Ethernet, etc.), connectivity and location management techniques, software applications/web sites, (e.g., social and/or business networking websites, business applications, games and other entertainment applications, etc.), programming languages, etc., while ensuring compatibility with changing technologies, parameters, protocols, standards, etc.

Throughout this document, terms like “logic”, “component”, “module”, “framework”, “engine”, “tool”, “circuitry”, and/or the like, may be referenced interchangeably and include, by way of example, software, hardware, firmware, and/or any combination thereof. In one example, “logic” may refer to or include a software component that works with one or more of an operating system, a graphics driver, etc., of a computing device, such as computing device 100. In another example, “logic” may refer to or include a hardware component that is capable of being physically installed along with or as part of one or more system hardware elements, such as an application processor, a graphics processor, etc., of a computing device, such as computing device 100. In yet another embodiment, “logic” may refer to or include a firmware component that is capable of being part of system firmware, such as firmware of an application processor or a graphics processor, etc., of a computing device, such as computing device 100.

It is contemplated that any number and type of components may be added to and/or removed from rekey mechanism 110A, rekey mechanism 110B, and/or rekey circuitry 120 of FIG. 1, FIGS. 2A/2B, and FIG. 3 to facilitate various embodiments including adding, removing, and/or enhancing certain features. For brevity, clarity, and ease of understanding of rekey mechanism 110A, rekey mechanism 110B and/or authorization circuitry 120 of FIG. 1, FIGS. 2A/2B, and FIG. 3, many of the standard and/or known components, such as those of a computing device are not shown or discussed here. It is contemplated that embodiments, as described herein, are not limited to any technology, topology, system, architecture, and/or standard and are dynamic enough to adopt and adapt to any future changes.

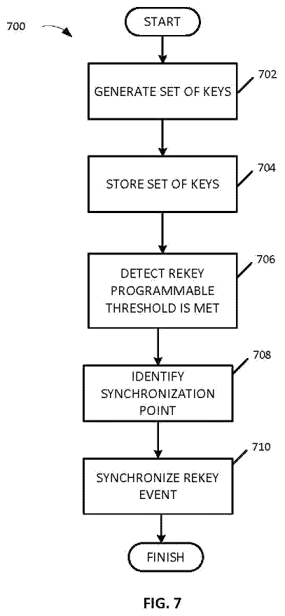

FIG. 7 illustrates a method 700 for mitigating side channel attacks on platform interconnects using endpoint HW based detection, synchronization, and re-keying without data loss according to some embodiments. Method 700 may be implemented on a computing device or a similar electronic device capable of executing instructions through at least one processor. Process 700 may begin at operation 702, where a set of keys is generated for link encryption based on a high entropy seed. At operation 704, the set of keys is stored in a deterministic order in a register. At operation 706, it is detected that a rekey programmable threshold is met during link encryption with a device. At operation 708, a synchronization point associated with the device is identified. In one example, the synchronization point indicates the device is ready to switch a current key used for link encryption. At operation 710, a rekeying event is synchronized with the device.

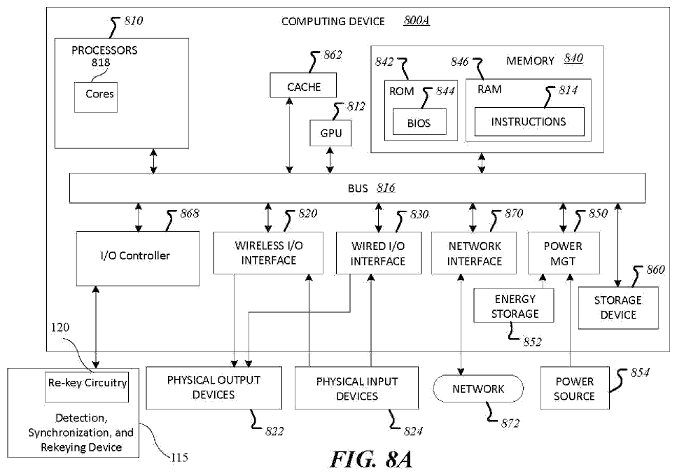

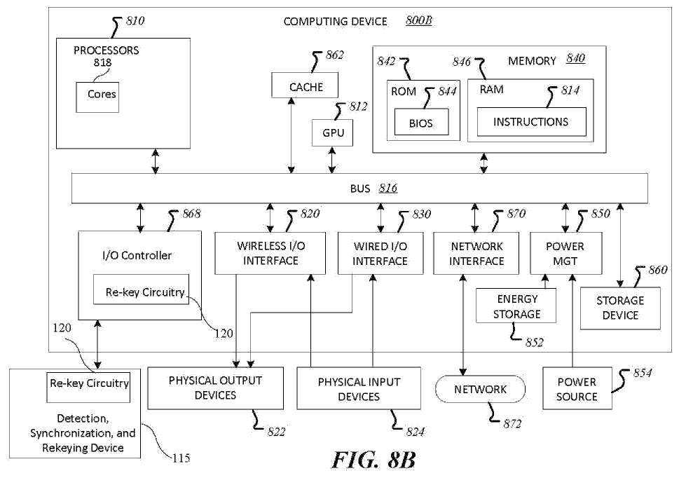

FIG. 8A is a schematic diagram of an illustrative electronic computing device to enhance mitigating side channel attacks on platform interconnects using endpoint HW based detection, synchronization, and re-keying processing according to some embodiments. In some embodiments, computing device 800A includes one or more processors 810 including processor cores 818. In some embodiments, the computing device 800A includes one or more I/O controllers 868. The one or more I/O controllers 868 may be communicably coupled to one or more detection, synchronization, and rekeying devices 115. The one or more detection, synchronization, and rekeying devices 115 may include any device as discussed herein relative to FIGS. 1-3 (e.g., an FPGA, CPU, smart-NIC and the like) and rekey circuitry 120 as discussed relative to FIG. 3. In some embodiments, the computing device is to implement processing of software-defined performance monitoring events, as provided in FIGS. 1-7 above.

The computing device 800A may additionally include one or more of the following: cache 862, a graphical processing unit (GPU) 812 (which may be the hardware accelerator in some implementations), a wireless input/output (I/O) interface 820, a wired I/O interface 830, system memory 840, power management circuitry 850, non-transitory storage device 860, and a network interface 870 for connection to a network 872. The following discussion provides a brief, general description of the components forming the illustrative computing device 800A. Example, non-limiting computing devices 800A may include a desktop computing device, blade server device, workstation, laptop computer, mobile phone, tablet computer, personal digital assistant, or similar device or system.

In embodiments, the processor cores 818 are capable of executing machine-readable instruction sets 814, reading data and/or machine-readable instruction sets 814 from one or more storage devices 860 and writing data to the one or more storage devices 860. Those skilled in the relevant art will appreciate that the illustrated embodiments as well as other embodiments may be practiced with other processor-based device configurations, including portable electronic or handheld electronic devices, for instance smartphones, portable computers, wearable computers, consumer electronics, personal computers (“PCs”), network PCs, minicomputers, server blades, mainframe computers, and the like. For example, machine-readable instruction sets 814 may include instructions to implement security processing, as provided in FIGS. 1-7.

The processor cores 818 may include any number of hardwired or configurable circuits, some or all of which may include programmable and/or configurable combinations of electronic components, semiconductor devices, and/or logic elements that are disposed partially or wholly in a PC, server, mobile phone, tablet computer, or other computing system capable of executing processor-readable instructions.

The computing device 800A includes a bus 816 or similar communications link that communicably couples and facilitates the exchange of information and/or data between various system components including the processor cores 818, the cache 862, the graphics processor circuitry 812, one or more wireless I/O interface 820, one or more wired I/O interfaces 830, one or more storage devices 860, and/or one or more network interfaces 870. The computing device 800A may be referred to in the singular herein, but this is not intended to limit the embodiments to a single computing device 800A, since in certain embodiments, there may be more than one computing device 800A that incorporates, includes, or contains any number of communicably coupled, collocated, or remote networked circuits or devices.

The processor cores 818 may include any number, type, or combination of currently available or future developed devices capable of executing machine-readable instruction sets.

The processor cores 818 may include (or be coupled to) but are not limited to any current or future developed single- or multi-core processor or microprocessor, such as: on or more systems on a chip (SOCs); central processing units (CPUs); digital signal processors (DSPs); graphics processing units (GPUs); application-specific integrated circuits (ASICs), programmable logic units, field programmable gate arrays (FPGAs), and the like. Unless described otherwise, the construction and operation of the various blocks shown in FIG. 8A are of conventional design. Consequently, such blocks need not be described in further detail herein, as they will be understood by those skilled in the relevant art. The bus 816 that interconnects at least some of the components of the computing device 800A may employ any currently available or future developed serial or parallel bus structures or architectures.

The system memory 840 may include read-only memory (“ROM”) 842 and random-access memory (“RAM”) 746. A portion of the ROM 842 may be used to store or otherwise retain a basic input/output system (“BIOS”) 844. The BIOS 844 provides basic functionality to the computing device 800A, for example by causing the processor cores 818 to load and/or execute one or more machine-readable instruction sets 814. In embodiments, at least some of the one or more machine-readable instruction sets 814 cause at least a portion of the processor cores 818 to provide, create, produce, transition, and/or function as a dedicated, specific, and particular machine, for example a word processing machine, a digital image acquisition machine, a media playing machine, a gaming system, a communications device, a smartphone, a neural network, a machine learning model, or similar devices.

The computing device 800A may include at least one wireless input/output (I/O) interface 820. The at least one wireless I/O interface 820 may be communicably coupled to one or more physical output devices 822 (tactile devices, video displays, audio output devices, hardcopy output devices, etc.). The at least one wireless I/O interface 820 may communicably couple to one or more physical input devices 824 (pointing devices, touchscreens, keyboards, tactile devices, etc.). The at least one wireless I/O interface 820 may include any currently available or future developed wireless I/O interface. Example wireless I/O interfaces include, but are not limited to: BLUETOOTH®, near field communication (NFC), and similar.

The computing device 800A may include one or more wired input/output (I/O) interfaces 830. The at least one wired I/O interface 830 may be communicably coupled to one or more physical output devices 822 (tactile devices, video displays, audio output devices, hardcopy output devices, etc.). The at least one wired I/O interface 830 may be communicably coupled to one or more physical input devices 824 (pointing devices, touchscreens, keyboards, tactile devices, etc.). The wired I/O interface 830 may include any currently available or future developed I/O interface. Example wired I/O interfaces include but are not limited to universal serial bus (USB), IEEE 1394 (“FireWire”), and similar.

The computing device 800A may include one or more communicably coupled, non-transitory, storage devices 860. The storage devices 860 may include one or more hard disk drives (HDDs) and/or one or more solid-state storage devices (SSDs). The one or more storage devices 860 may include any current or future developed storage appliances, network storage devices, and/or systems. Non-limiting examples of such storage devices 860 may include, but are not limited to, any current or future developed non-transitory storage appliances or devices, such as one or more magnetic storage devices, one or more optical storage devices, one or more electro-resistive storage devices, one or more molecular storage devices, one or more quantum storage devices, or various combinations thereof. In some implementations, the one or more storage devices 860 may include one or more removable storage devices, such as one or more flash drives, flash memories, flash storage units, or similar appliances or devices capable of communicable coupling to and decoupling from the computing device 800A.

The one or more storage devices 860 may include interfaces or controllers (not shown) communicatively coupling the respective storage device or system to the bus 816. The one or more storage devices 860 may store, retain, or otherwise contain machine-readable instruction sets, data structures, program modules, data stores, databases, logical structures, and/or other data useful to the processor cores 818 and/or graphics processor circuitry 812 and/or one or more applications executed on or by the processor cores 818 and/or graphics processor circuitry 812. In some instances, one or more data storage devices 860 may be communicably coupled to the processor cores 818, for example via the bus 816 or via one or more wired communications interfaces 830 (e.g., Universal Serial Bus or USB); one or more wireless communications interface 820 (e.g., Bluetooth®, Near Field Communication or NFC); and/or one or more network interfaces 870 (IEEE 802.3 or Ethernet, IEEE 802.11, or Wi-Fi®, etc.).

Machine-readable instruction sets 814 and other programs, applications, logic sets, and/or modules may be stored in whole or in part in the system memory 840. Such machine-readable instruction sets 814 may be transferred, in whole or in part, from the one or more storage devices 860. The machine-readable instruction sets 814 may be loaded, stored, or otherwise retained in system memory 840, in whole or in part, during execution by the processor cores 818 and/or graphics processor circuitry 812.

The computing device 800A may include power management circuitry 850 that controls one or more operational aspects of the energy storage device 852. In embodiments, the energy storage device 852 may include one or more primary (i.e., non-rechargeable) or secondary (i.e., rechargeable) batteries or similar energy storage devices. In embodiments, the energy storage device 852 may include one or more supercapacitors or ultracapacitors.

For convenience, the processor cores 818, the graphics processor circuitry 812, the wireless I/O interface 820, the wired I/O interface 830, the storage device 860, and the network interface 870 are illustrated as communicatively coupled to each other via the bus 816, thereby providing connectivity between the above-described components. In alternative embodiments, the above-described components may be communicatively coupled in a different manner than illustrated in FIG. 8A. For example, one or more of the above-described components may be directly coupled to other components, or may be coupled to each other, via one or more intermediary components (not shown). In another example, one or more of the above-described components may be integrated into the processor cores 818 and/or the graphics processor circuitry 812. In some embodiments, all or a portion of the bus 816 may be omitted and the components are coupled directly to each other using suitable wired or wireless connections.

Flow charts representative of example hardware logic, machine readable instructions, hardware implemented state machines, and/or any combination thereof for implementing computing device 800A, for example, are shown in FIG. 7. The machine-readable instructions may be one or more executable programs or portion(s) of an executable program for execution by a computer processor such as the processor 810 shown in the example computing device 800A discussed above in connection with FIG. 8A. The program may be embodied in software stored on a non-transitory computer readable storage medium such as a CD-ROM, a floppy disk, a hard drive, a DVD, a Blu-ray disk, or a memory associated with the processor 810, but the entire program and/or parts thereof could alternatively be executed by a device other than the processor 810 and/or embodied in firmware or dedicated hardware. Further, although the example program is described with reference to the flow charts illustrated in FIG. 7, many other methods of implementing the example computing device 800A may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware.

The machine-readable instructions described herein may be stored in one or more of a compressed format, an encrypted format, a fragmented format, a compiled format, an executable format, a packaged format, etc. Machine readable instructions as described herein may be stored as data (e.g., portions of instructions, code, representations of code, etc.) that may be utilized to create, manufacture, and/or produce machine executable instructions. For example, the machine-readable instructions may be fragmented and stored on one or more storage devices and/or computing devices (e.g., servers). The machine-readable instructions may require one or more of installation, modification, adaptation, updating, combining, supplementing, configuring, decryption, decompression, unpacking, distribution, reassignment, compilation, etc. in order to make them directly readable, interpretable, and/or executable by a computing device and/or other machine. For example, the machine-readable instructions may be stored in multiple parts, which are individually compressed, encrypted, and stored on separate computing devices, wherein the parts when decrypted, decompressed, and combined form a set of executable instructions that implement a program such as that described herein.

In another example, the machine-readable instructions may be stored in a state in which they may be read by a computer, but require addition of a library (e.g., a dynamic link library (DLL)), a software development kit (SDK), an application programming interface (API), etc. in order to execute the instructions on a particular computing device or other device. In another example, the machine-readable instructions may be configured (e.g., settings stored, data input, network addresses recorded, etc.) before the machine-readable instructions and/or the corresponding program(s) can be executed in whole or in part. Thus, the disclosed machine-readable instructions and/or corresponding program(s) are intended to encompass such machine-readable instructions and/or program(s) regardless of the particular format or state of the machine-readable instructions and/or program(s) when stored or otherwise at rest or in transit.

The machine-readable instructions described herein can be represented by any past, present, or future instruction language, scripting language, programming language, etc. For example, the machine-readable instructions may be represented using any of the following languages: C, C++, Java, C#, Perl, Python, JavaScript, HyperText Markup Language (HTML), Structured Query Language (SQL), Swift, etc.

As mentioned above, the example method of FIG. 7 may be implemented using executable instructions (e.g., computer and/or machine-readable instructions) stored on a non-transitory computer and/or machine-readable medium such as a hard disk drive, a solid-state storage device (SSD), a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended.

The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C. As used herein in the context of describing structures, components, items, objects and/or things, the phrase “at least one of A and B” is intended to refer to implementations including any of (1) at least one A, (2) at least one B, and (3) at least one A and at least one B. Similarly, as used herein in the context of describing structures, components, items, objects and/or things, the phrase “at least one of A or B” is intended to refer to implementations including any of (1) at least one A, (2) at least one B, and (3) at least one A and at least one B. As used herein in the context of describing the performance or execution of processes, instructions, actions, activities, the phrase “at least one of A and B” is intended to refer to implementations including any of (1) at least one A, (2) at least one B, and (3) at least one A and at least one B. Similarly, as used herein in the context of describing the performance or execution of processes, instructions, actions, activities, the phrase “at least one of A or B” is intended to refer to implementations including any of (1) at least one A, (2) at least one B, and (3) at least one A and at least one B.

As used herein, singular references (e.g., “a”, “an”, “first”, “second”, etc.) do not exclude a plurality. The term “a” or “an” entity, as used herein, refers to one or more of that entity. The terms “a” (or “an”), “one or more”, and “at least one” can be used interchangeably herein. Furthermore, although individually listed, a plurality of means, elements or method actions may be implemented by, e.g., a single unit or processor. Additionally, although individual features may be included in different examples or claims, these may possibly be combined, and the inclusion in different examples or claims does not imply that a combination of features is not feasible and/or advantageous.

Descriptors “first,” “second,” “third,” etc. are used herein when identifying multiple elements or components which may be referred to separately. Unless otherwise specified or understood based on their context of use, such descriptors are not intended to impute any meaning of priority, physical order or arrangement in a list, or ordering in time but are merely used as labels for referring to multiple elements or components separately for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for ease of referencing multiple elements or components.

FIG. 8B is a schematic diagram of an illustrative electronic computing device to enhance mitigating side channel attacks on platform interconnects using endpoint HW based detection, synchronization, and re-keying processing according to some embodiments. In some embodiments, the computing device 800B is to implement processing of software-defined performance monitoring events, as provided in FIGS. 1-7 above. The computing device 800B may additionally include the components forming the illustrative computing device 800A described herein relative to FIG. 8A such as one or more of the following: cache 862, a graphical processing unit (GPU) 812 (which may be the hardware accelerator in some implementations), a wireless input/output (I/O) interface 820, a wired I/O interface 830, system memory 840, power management circuitry 850, non-transitory storage device 860, a network interface 870 for connection to a network 872, machine-readable instructions sets 814, one or more storage devices 860, I/O controller 868, and the like. I/O controller 868 may include rekey circuitry 120 as discussed relative to FIG. 3. I/O controller 868 may be communicably coupled to one or more detection, synchronization, and rekeying devices 115. The one or more detection, synchronization, and rekeying devices 115 may include any device as discussed herein relative to FIGS. 1-3 (e.g., an FPGA, CPU, smart-NIC and the like) and rekey circuitry 120 as discussed relative to FIG. 3.

In this regard, the computing device 800B may include any or all of the non-limiting examples of computing device 800A described relative to FIG. 8A. Additionally, the computing device 800B may perform, execute and/or implement processing of any or all of the functions, methods, processes performed, executed and/or implemented by computing device 800A described relative to FIG. 8A.

The following examples pertain to further embodiments. Example 1 is a method including generating a set of keys for link encryption based on a high entropy seed, storing the set of keys in a deterministic order in a register, detecting that a re-key programmable threshold is met during link encryption with a device, identifying a synchronization point associated with the device, where the synchronization point indicates the device is ready to switch a current key used for link encryption, and synchronizing a rekeying event with the device.
In Example 2, the subject matter of Example 1 can optionally include wherein the re-key programmable threshold includes one or more conditions to set up a rekeying frequency.
In Example 3, the subject matter of any one of Examples 1-2 can optionally include wherein the one or more conditions include at least one of an amount of time since a last key update, a number of bytes since a last key update, and a number of packets since a last key update.
In Example 4, the subject matter of any one of Examples 1-3 can optionally include wherein the device includes at least an interconnect controller at the opposite end of the encryption link.
In Example 5, the subject matter of any one of Examples 1-4 can optionally include wherein synchronizing a rekeying event with the device comprises: providing a trigger to the device indicating to the device that it is time to switch the current key used for link encryption, switching the current key used for link encryption, and generating another synchronization point with the device to program a backup key slot with a next key of the set of keys stored in the register.
In Example 6, the subject matter of any one of Examples 1-5 can optionally include wherein the deterministic order in the register facilitates synchronization of keys to be used for link encryption.
In Example 7, the subject matter of any one of Examples 1-6 can optionally include wherein when the register has reached a stored keys threshold, the method further comprises generating a new high entropy seed that is sent to the device as a custom message.
In Example 8, the subject matter of any one of Examples 1-7 can optionally include wherein the link is peripheral component interconnect express (PCIe), and wherein the link encryption is on the PCIe link.
Example 9 is at least one non-transitory machine-readable storage medium comprising instructions that, when executed, cause at least one processing device to at least: generate a set of keys for link encryption based on a high entropy seed, store the set of keys in a deterministic order in a register, detect that a re-key programmable threshold is met during link encryption with a device, identify a synchronization point associated with the device, where the synchronization point indicates the device is ready to switch a current key used for link encryption, and synchronize a rekeying event with the device.
In Example 10, the subject matter of Example 9 can optionally include wherein the re-key programmable threshold includes one or more conditions to set up a rekeying frequency.
In Example 11, the subject matter of any one of Examples 9-10 can optionally include wherein the one or more conditions include at least one of an amount of time since a last key update, a number of bytes since a last key update, and a number of packets since a last key update.
In Example 12, the subject matter of any one of Examples 9-11 can optionally include wherein to detect that a re-key programmable threshold is met during link encryption with a device, the instructions that, when executed, further cause the at least one processing device to count towards the re-key programmable threshold.
In Example 13, the subject matter of any one of Examples 9-12 can optionally include wherein to synchronize a rekeying event with the device, the instructions that, when executed, further cause the at least one processing device to: provide a trigger to the device indicating to the device that it is time to switch the current key used for link encryption, switch the current key used for link encryption, and generate another synchronization point with the device to program a backup key slot with a next key of the set of keys stored in the register.
In Example 14, the subject matter of any one of Examples 9-13 can optionally include wherein the device includes at least an interconnect controller at the opposite end of the encryption link.
Example 15 is an apparatus comprising: one or more processors to: generate a set of keys for link encryption based on a high entropy seed, store the set of keys in a deterministic order in a register, detect that a re-key programmable threshold is met during link encryption with a device, identify a synchronization point associated with the device, where the synchronization point indicates the device is ready to switch a current key used for link encryption, and synchronize a rekeying event with the device.
In Example 16, the subject matter of Example 15 can optionally include wherein the re-key programmable threshold includes one or more conditions to set up a rekeying frequency, and wherein the one or more conditions include at least one of an amount of time since a last key update, a number of bytes since a last key update, and a number of packets since a last key update.
In Example 17, the subject matter of any one of Examples 15-16 can optionally include wherein the device includes at least an interconnect controller at the opposite end of the encryption link.
In Example 18, the subject matter of any one of Examples 15-17 can optionally include wherein to detect that a re-key programmable threshold is met during link encryption with a device, the one or more processors count towards the re-key programmable threshold.
In Example 19, the subject matter of any one of Examples 15-18 can optionally include wherein to synchronize a rekeying event with the device, the one or more processors: provide a trigger to the device indicating to the device that it is time to switch the current key used for link encryption, switch the current key used for link encryption, and generate another synchronization point with the device to program a backup key slot with a next key of the set of keys stored in the register.
In Example 20, the subject matter of any one of Examples 15-19 can optionally include wherein the link is peripheral component interconnect express (PCIe), and wherein the link encryption is on the PCIe link.
Example 21 is a system including one or more processors coupled to a memory, wherein the one or more processors are operative to perform the method of any one of Examples 1 to 8.
Example 22 is a method including receiving a trigger indicating that it is time to switch a current key of a set of keys used for link encryption in response to a re-key programmable threshold being met during link encryption, switching the current key used for link encryption, programing a backup key slot with a next key of the set of keys stored in a register, and setting a ready to rekey bit.
In Example 23, the subject matter of claim 22 can optionally include wherein the set of keys are stored in a deterministic order in the register.
In Example 24, the subject matter of any one of Examples 22-23 can optionally include wherein the set of keys are generated based on a high entropy seed.
In Example 25, the subject matter of any one of Examples 22-24 can optionally include wherein the re-key programmable threshold includes one or more conditions to set up a rekeying frequency.
In Example 26, the subject matter of any one of Examples 22-25 can optionally include wherein the one or more conditions include at least one of an amount of time since a last key update, a number of bytes since a last key update, and a number of packets since a last key update.
In Example 27, the subject matter of any one of Examples 22-26 can optionally include wherein the deterministic order in the register facilitates synchronization of keys to be used for link encryption.
In Example 28, the subject matter of any one of Examples 22-27 can optionally include wherein when the register has reached a stored keys threshold, the method further comprises generating a new high entropy seed.
In Example 29, the subject matter of any one of Examples 22-28 can optionally include wherein the link is peripheral component interconnect express (PCIe), and wherein the link encryption is on the PCIe link.
Example 30 is a system including one or more processors coupled to a memory, wherein the one or more processors are operative to perform the method of any one of Examples 22-29.
Example 31 is an apparatus comprising: one or more processors to perform the method of any one of Examples 22-29.
Example 32 is at least one non-transitory machine-readable storage medium comprising instructions that, when executed, cause at least one processing device to at least perform the method of any one of Examples 22-29.

The foregoing description and drawings are to be regarded in an illustrative rather than a restrictive sense. Persons skilled in the art will understand that various modifications and changes may be made to the embodiments described herein without departing from the broader spirit and scope of the features set forth in the appended claims.

What is claimed is:

1. A method comprising:
generating a set of keys for link encryption based on a high entropy seed;
storing the set of keys in a deterministic order in a register;
detecting that a re-key programmable threshold is met during link encryption with a device;
identifying a synchronization point associated with the device, where the synchronization point indicates the device is ready to switch a current key used for link encryption; and
synchronizing a rekeying event with the device.

2. The method of claim 1, wherein the re-key programmable threshold includes one or more conditions to set up a rekeying frequency.

3. The method of claim 2, wherein the one or more conditions include at least one of an amount of time since a last key update, a number of bytes since a last key update, and a number of packets since a last key update.

4. The method of claim 1, wherein the device includes at least an interconnect controller at the opposite end of the encryption link.

5. The method of claim 1, wherein synchronizing a rekeying event with the device comprises:
providing a trigger to the device indicating to the device that it is time to switch the current key used for link encryption;
switching the current key used for link encryption; and
generating another synchronization point with the device to program a backup key slot with a next key of the set of keys stored in the register.

6. The method of claim 1, wherein the deterministic order in the register facilitates synchronization of keys to be used for link encryption.

7. The method of claim 1, wherein when the register has reached a stored keys threshold, the method further comprises generating a new high entropy seed that is sent to the device as a custom message.

8. The method of claim 1, wherein the link is peripheral component interconnect express (PCIe), and wherein the link encryption is on the PCIe link.

9. At least one non-transitory machine-readable storage medium comprising instructions that, when executed, cause at least one processing device to at least:
generate a set of keys for link encryption based on a high entropy seed;
store the set of keys in a deterministic order in a register;
detect that a re-key programmable threshold is met during link encryption with a device;
identify a synchronization point associated with the device, where the synchronization point indicates the device is ready to switch a current key used for link encryption; and
synchronize a rekeying event with the device.

10. The at least one non-transitory machine-readable storage medium of claim 9, wherein the re-key programmable threshold includes one or more conditions to set up a rekeying frequency.

11. The at least one non-transitory machine-readable storage medium of claim 10, wherein the one or more conditions include at least one of an amount of time since a last key update, a number of bytes since a last key update, and a number of packets since a last key update.

12. The at least one non-transitory machine-readable storage medium of claim 9, wherein to detect that a re-key programmable threshold is met during link encryption with a device, the instructions that, when executed, further cause the at least one processing device to count towards the re-key programmable threshold.

13. The at least one non-transitory machine-readable storage medium of claim 9, wherein to synchronize a rekeying event with the device, the instructions that, when executed, further cause the at least one processing device to:
provide a trigger to the device indicating to the device that it is time to switch the current key used for link encryption;
switch the current key used for link encryption; and
generate another synchronization point with the device to program a backup key slot with a next key of the set of keys stored in the register.

14. The at least one non-transitory machine-readable storage medium of claim 9, wherein the device includes at least an interconnect controller at the opposite end of the encryption link.

15. An apparatus comprising:
one or more processors to:
generate a set of keys for link encryption based on a high entropy seed;
store the set of keys in a deterministic order in a register;
detect that a re-key programmable threshold is met during link encryption with a device;
identify a synchronization point associated with the device, where the synchronization point indicates the device is ready to switch a current key used for link encryption; and
synchronize a rekeying event with the device.

16. The apparatus of claim 15, wherein the re-key programmable threshold includes one or more conditions to set up a rekeying frequency, and wherein the one or more conditions include at least one of an amount of time since a last key update, a number of bytes since a last key update, and a number of packets since a last key update.

17. The apparatus of claim 16, wherein the device includes at least an interconnect controller at the opposite end of the encryption link.

18. The apparatus of claim 15, wherein to detect that a re-key programmable threshold is met during link encryption with a device, the one or more processors count towards the re-key programmable threshold.

19. The apparatus of claim 15, wherein to synchronize a rekeying event with the device, the one or more processors:
provide a trigger to the device indicating to the device that it is time to switch the current key used for link encryption;
switch the current key used for link encryption; and
generate another synchronization point with the device to program a backup key slot with a next key of the set of keys stored in the register.

20. The apparatus of claim 15, wherein the link is peripheral component interconnect express (PCIe), and wherein the link encryption is on the PCIe link.
